(19) United States
(12) Patent Application Publication
(10) Pub. No.: US 2008/0306206 A1
(43) Pub. Date: Dec. 11, 2008

(54) Saturant and fiber composite structure

(76) Inventor: Daniel Lee Neumann, Ponchatoula, LA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/154,316

(22) Filed: May 22, 2008

Related U.S. Application Data
(60) Provisional application No. 60/933,352, filed on Jun. 6, 2007.

(51) Int. Cl. C08L 27/04

(52) U.S. Cl. 524/551

(57) ABSTRACT

Composite structures are manufactured from fiber and saturant. The saturant composition comprises a polymerization initiator system and a binder of chlorosulfonated polyolefin and a monomer mixture. The monomer mixture comprises 1) (meth)acrylic monomers having a single (meth)acrylic group and 2) (meth)acrylate monomers having at least two (meth)acrylate groups.

### CROSS-REFERENCE TO RELATED APPLICATIONS

This application claims the benefit of U.S. Provisional Application No. 60/933,352 filed Jun. 6, 2007.

### FIELD OF THE INVENTION

This invention is related to composite structures comprising fiber and a saturant composition, said saturant comprising a polymerization initiator system and a binder, said binder comprising chlorosulfonated polyolefin and polymerizable monomers.

### BACKGROUND OF THE INVENTION

Today, many structural components that were previously fabricated from metal, have been replaced with molded composite materials. These composite structures typically consist of a fiber mat that has been impregnated with a polymeric composition and cured into the final shape.

Common polymeric systems are based upon epoxies, polyurethanes and acrylics. These systems each have their individual limitations but one of the common limitations is a deficiency in sudden impact resistance (i.e. they are brittle). This can lead to failure of the composite through cracking of the polymeric composition or de-lamination from the fiber reinforcing structure which weakens the composite structure and leads to failure. This is especially a problem when composite structures are fabricated to hold liquids and failure leads to leaks. Other structural parts tend to crack or craze under low impact, which leads to failure or appearance problems requiring repairs. This is especially true for recreational equipment and consumer equipment. Thus, there is a need for a composite structure with increased flexibility and adhesion to fibrous materials in order to improve impact resistance, weatherability and de-lamination problems.

Adhesive compositions comprising a chlorosulfonated polyethylene polymer, (meth)acrylic monomer and catalyst are known (e.g. U.S. Pat. No. 3,890,407).

U.S. Pat. No. 4,226,954 discloses an improved, low odor, composition based on chlorosulfonated polyethylene, C₁₀-C₁₈ (meth)acrylate monomer, di(meth)acrylate, organic peroxide, and an aldehyde-amine condensation product.

Patches for hollow articles are disclosed in U.S. Pat. No. 4,568,589. The patches are fibrous cloth that is impregnated with chlorosulfonated polyethylene based adhesive compositions of the types disclosed in U.S. Pat. No. 3,890,407; U.S. Pat. No. 4,182,644 and U.S. Pat. No. 4,536,546.

### SUMMARY OF THE INVENTION

The present invention relates to a composite structure comprising:

A) fiber and

B) a saturant composition comprising: (i) a binder composition and (ii) a polymerization initiator system, wherein said binder composition comprises:
a) 1 to 50 percent by weight, based on total weight of binder, of chlorosulfonated polyolefin; and
b) 99 to 50 percent by weight, based on total weight of binder, of a monomer mixture,
   wherein said monomer mixture comprises 10 to 99 weight percent, based on total weight of said monomer mixture, of at least one first monomer selected from the group consisting of acrylic monomers, methacrylic monomers and a mixture of acrylic and methacrylic monomers, wherein said first monomer has a single acrylic or methacrylic group; and 90 to 1 weight percent, based on total weight of said monomer mixture, of at least one second monomer selected from the group consisting of acrylate monomers, methacrylate monomers and a mixture of acrylate and methacrylate monomers, wherein said second monomer has at least two acrylate or methacrylate groups.

### DETAILED DESCRIPTION OF THE INVENTION

The present invention is directed to a composite structure comprising fiber and saturant for use in producing a new article.

By the term “fiber” is meant synthetic or natural fibers and includes filaments, staple, woven and nonwoven fabrics or mats, etc. Specific examples of such fibers include, but are not limited to fiberglass, polyester, polyamides, aromatic polyamides, carbon fiber and metallic fiber. Preferably the composite structures of the invention contain at least 10 weight percent (wt. %) fiber, based on the total weight of fiber and saturant, and may contain up to 50 to 60 weight percent fiber.

As used herein, the term “saturant” means a composition comprising i) binder and ii) a polymerization initiator system.

The binder comprises in the range of from 1 weight percent (wt. %) to 50 wt. % chlorosulfonated polyolefin, based on total weight of the binder. More preferably, the binder contains from 10 wt. % to 40 wt. % chlorosulfonated polyolefin and most preferably, the binder contains from 15 wt. % to 30 wt. % chlorosulfonated polyolefin.

The chlorosulfonated polyolefin as used herein means those chlorosulfonated polyolefins or polyolefin copolymers and their partially neutralized salts which contain chlorine in an amount between 1 and 60 percent by weight and sulfur in an amount between 0.25 and 10 percent by weight, all weights based upon the weight of the chlorosulfonated polyolefin. The chlorosulfonated polyolefin can include chlorosulfonated homopolymers of C₂ to C₁₈ monoolefins, chlorosulfonated copolymers of ethylene and carbon monoxide, and chlorosulfonated copolymers of ethylene and at least one ethylenically unsaturated monomer. The ethylenically unsaturated comonomer can be chosen from C₃ to C₁₀ alpha monoolefins, C₁ to C₁₂ alkyl esters of unsaturated C₃ to C₂₀ monocarboxylic acids, unsaturated C₃ to C₂₀ mono- or dicarboxylic acids, and vinyl esters of saturated C₂ to C₁₈ carboxylic acids.

Suitable chlorosulfonated polyolefins include, but are not limited to chlorosulfonated polyethylene; chlorosulfonated polypropylene; chlorosulfonated polybutene; chlorosulfonated polyisobutylene; chlorosulfonated polydecene; chlorosulfonated ethylene/vinyl acetate copolymers; chlorosulfonated ethylene/carbon monoxide copolymers; chlorosulfonated ethylene/acrylic acid copolymers; chlorosulfonated ethylene/methacrylic acid copolymers; chlorosulfonated ethylene/methyl acrylate copolymers; chlorosulfonated ethylene/methyl methacrylate copolymers; chlorosulfonated ethylene/n-butyl acrylate copolymers; chlorosulfonated ethylene/n-butyl methacrylate copolymers; chlorosulfonated ethylene/glycidyl acrylate copolymers; chlorosulfonated ethylene/glycidyl methacrylate copolymers; chlorosulfonated maleic anhydride grafted polypropylene and polyethylene polymers; chlorosulfonated ethylene/propylene and ethylene/propylene/diene copolymers; and chlorosulfonated copolymers of ethylene with propylene, 1-butene, 3-methyl-1-pentene, 1-hexene, 1-octene or a combination thereof.

Partially neutralized chlorosulfonated polyolefin or polyolefin copolymer salts are made by neutralizing with base a portion of the pendant —SO₂Cl groups on chlorosulfonated polyolefin homopolymer or copolymer. Typically only about 10 to 90% (as evidenced by FTIR measurements or titration analysis) of the —SO₂Cl groups react with base to form a plurality of —SO₃M groups, so that the chlorosulfonated polyolefins are termed “partially neutralized”. The cation, M, originates with the base employed in the neutralization reaction and may be univalent or multivalent. M is preferably sodium ion. Examples of bases that may be utilized in the neutralization reaction include, but are not limited to ammonium hydroxide, sodium hydroxide, sodium carbonate, potassium hydroxide, lithium hydroxide, magnesium hydroxide, calcium hydroxide, aluminum hydroxide, and amine bases such as alkyl amines and various ethoxylated amines. A combination of inorganic base and amine may be used.

Suitable chlorosulfonated polyolefins typically have weight average molecular weights in the range of from 1,000 to 300,000. Preferred chlorosulfonated polyolefins have weight average molecular weights in the range of from 5,000 to 250,000. More preferably, the chlorosulfonated polyolefins have weight average molecular weights in the range of from 10,000 to 200,000. At the time of this disclosure, suitable chlorosulfonated polyolefins are available commercially as Hypalon® and Acsium® from DuPont Performance Elastomers, Wilmington, Del.

The binder further comprises from 50 wt. % to 99 wt. %, based on the total weight of binder, of a monomer mixture. The monomer mixture comprises i) 10 to 99 (preferably 15 to 85, most preferably 20 to 80) wt. %, based on total weight of monomer mixture, of at least one first monomer that contains only a single (meth)acrylic group and ii) 90 wt. % to 1 (preferably 85 to 15, most preferably 80 to 20) wt. % of at least one second monomer that contains at least two (meth)acrylate groups (i.e. a di-, tri- or higher (meth)acrylate monomer). By the term “(meth)acrylic” is meant acrylic or methacrylic acids, esters, amides, nitrites and mixtures thereof. The term “(meth)acrylate” means alkyl acrylates, alkyl methacrylates and mixtures of both alkyl acrylates and alkyl methacrylates.

Suitable (meth)acrylic monomers having only a single (meth)acrylic group include, but are not limited to alkyl, cycloaliphatic and aromatic esters of (meth)acrylic acid; (meth)acrylonitrile; (meth)acrylamide; maleic acid; fumaric acid; itaconic acid; or combinations thereof. Preferred (meth)acrylate monomers having only a single (meth)acrylate group include, but are not limited to methyl acrylate; methyl methacrylate; 2-ethyl hexyl acrylate; 2-ethyl hexyl methacrylate; butyl acrylate; butyl methacrylate; isobornyl acrylate; isobornyl methacrylate; isodecyl acrylate; isodecyl methacrylate; isotridecyl acrylate; isotridecyl methacrylate; acetoacetoxyethyl acrylate; acetoacetoxyethyl methacrylate; and polyester (meth)acrylates such as the TONE® monomers available at the time of this disclosure from The Dow Chemical Company, Midland, Mich. Preferably, the first (meth)acrylic monomer having only a single (meth)acrylic group is an alkyl (meth)acrylate wherein the alkyl group contains between 3 and 18 carbon atoms, more preferably 6 to 18 carbon atoms.

A portion, up to 50 wt. %, of the total amount of (meth)acrylic monomer that contains only a single (meth)acrylic group can be replaced by another monomer such as a vinyl ester, vinyl ether, styrene, or a combination of 2 or more of the latter monomers.

Examples of (meth)acrylate monomers having at least 2 (meth)acrylate groups that may be employed in the invention include, but are not limited to ethylene glycol di(meth)acrylate; diethyleneglycol di(meth)acrylate; triethyleneglycol di(meth)acrylate; tetraethylene glycol di(meth)acrylate; polyethylene glycol di(meth)acrylate; isomers of propanediol di(meth)acrylates; isomers of butanediol di(meth)acrylates; isomers of hexanediol di(meth)acrylate; 2,2-dimethylpropanediol di(meth)acrylate; tripropylene glycol di(meth)acrylate; 1,3-butylene glycol di(meth)acrylate; polyalkylene glycol di(meth)acrylates; cyclohexane dimethanol di(meth)acrylate; trimethylolpropane tri(meth)acrylate; polyalkylene triol tri(meth)acrylates; pentaerythritol tri(meth)acrylate; and pentaerythritol tetra(meth)acrylate. Other useful di(meth)acrylate monomers are isomers of polyalkanediol (meth)acrylates wherein the alkane portion contains in the range of from 2 to 30 carbon atoms. There is essentially no upper limit to the number of carbon atoms in the alkane group. However, at greater than 30 carbon atoms, the materials tend to be solids which make them less useful in a liquid spray application.

Urethane di-, tri-, or higher (meth)acrylates can also be used as the (meth)acrylate monomer that contains at least two (meth)acrylate groups since they can impart increased flexibility to the cured composite and reduced brittleness. They can be produced by any of the methods known to those in the art. Two typical methods are 1) reacting a polyisocyanate with a hydroxy-containing (meth)acrylate, such as 2-hydroxyethyl (meth)acrylate; and 2) reacting an isocyanato(meth)acrylate with a suitable polyol.

A portion (up to about 25 percent by weight) of the total amount of (meth)acrylate monomer that has at least two (meth)acrylate groups can be replaced by at least one non-(meth)acrylate monomer that has at least two olefinically unsaturated groups that are capable of free radical polymerization. Suitable non-(meth)acrylate monomers that have at least two olefinically unsaturated groups that are capable of free radical polymerization include, but are not limited to liquid polyisoprenes, liquid polybutadienes, limonene, linoleic and linolenic acids and their esters, and ortho-, meta-, and para-isomers of N,N-phenylenedimaleimide.

In order to manufacture the binder, the chlorosulfonated polyolefin can be dissolved in the monomer mixture to form a solution, or the chlorosulfonated polyolefin can be suspended in the monomer mixture. Preferably, the chlorosulfonated polyolefin forms a solution in the monomer mixture. The binder is produced by agitating the chlorosulfonated polyolefin and the monomer mixture for a sufficient amount of time to disperse or dissolve the chlorosulfonated polyolefin in the monomer mixture. Optionally, the mixture can be heated to obtain the desired solution or suspension. If the mixture is heated, care should be taken so that the monomer mixture does not thermally polymerize, i.e. by ensuring the absence of thermal catalysts and/or by regulating the temperature of the mixture. Preferably, the mixture remains in solution without the formation of precipitates or phase separation upon removal of the agitation. More preferably, the composition remains in solution without the formation of precipitates or phase separation for at least one month.

The saturant composition further includes a polymerization initiator system. Suitable polymerization initiator systems may comprise any initiator or combination of initiators useful for generating free radicals, e.g. peroxides, peracids, peresters, and azo initiators. Also included in a typical polymerization initiator system is one or more polymerization activators such as organometallic activators and amine based activators (e.g. tertiary amines). The following concentrations of polymerization initiator system components have been found to be suitable for use in the practice of the present invention: 0.05 wt. % to 10 wt. %, based on total weight of binder, for peroxides, peracids, peresters and azo initiators; and 0.1 wt. % to 5 wt. % for amine based activators. Organometallic activators can be present in the range of from 0.001 wt. % to 5 wt. %, based upon the total weight of the binder.

Examples of suitable peroxides, peracids, and peresters include, but are not limited to hydrogen peroxide; m-chloroperoxy benzoic acid; t-butyl peroxyacetate; t-butyl peroxybenzoate; t-butyl peroxyoctoate; t-butyl peroxyneodecanoate; t-butylperoxy isobutyrate; t-amyl peroxypivalate; t-butyl peroxypivalate; di-isopropyl peroxydicarbonate; dicyclohexyl peroxydicarbonate; dicumyl peroxide; dibenzoyl peroxide; dilauroyl peroxide; potassium peroxydisulfate; ammonium peroxydisulfate; cumene hydrogen peroxide; t-butyl peroxide; di t-butyl peroxide; t-amyl peroxyacetate or any combination thereof.

Suitable azo initiators include, but are not limited to azocumene; 2,2′-azobis(isobutyronitrile) (Vazo® 64 thermal initiator supplied by Du Pont Company, Wilmington, Del.); 4,4′-azobis(4-cyanovaleric acid) (Vazo® 52 thermal initiator supplied by Du Pont Company, Wilmington, Del.) and 2-(t-butylazo)-2-cyanopropane, 2,2′-azobis(2-methylbutanenitrile); dimethyl 2,2′-azobis(methyl isobutyrate); 4,4′-azobis(4-cyanopentanoic acid); 4,4′-azobis(4-cyanopentan-1-ol); 1,1′-azobis(cyclohexanecarbonitrile); 2-(t-butylazo)-2-cyanopropane; 2,2′-azobis[2-methyl-N-(1,1)-bis(hydoxymethyl)-2-hydroxyethyl] propionamide; 2,2′-azobis[2-methyl-N-hydroxyethyl)]-propionamide; 2,2′-azobis(N, N′-dimethyleneisobutyramidine) dihydrochloride; 2,2′-azobis(2-amidinopropane) dihydrochloride; 2,2′-azobis(N,N′-dimethyleneisobutyramine); 2,2′-azobis(2-methyl-N-[1,1-bis(hydroxymethyl)-2-hydroxyethyl]propionamide); 2,2′-azobis(2-methyl-N-[1,1-bis(hydroxymethyl) ethyl]propionamide); 2,2′-azobis[2-methyl-N-(2-hydroxyethyl) propionamide]; 2,2′-azobis(isobutyramide) dihydrate, 2,2′-azobis(2,2,4-trimethylpentane); 2,2′-azobis(2-methylpropane); or any combination thereof.

Suitable amine-based activators include, but are not limited to N,N-dimethylaniline; N,N-diethylaniline; N,N-diisopropyl-p-toluidine; substituted 1,2-dihydropyridines; guanidine; or a combination thereof.

Organometallic activators, such as the organic acid salt of a transition metal, for example, copper, cobalt, nickel, manganese or iron naphthenate, octoate, hexanoate, and/or propionate can optionally be added.

The saturant composition can also include pigments. Typical pigments that can be used in the composition are well known to one of ordinary skill in the coating art. Suitable pigments include, for example talc, china clay, barites, carbonates, silicates, and colored pigment such as metallic oxides, e.g. titanium dioxide, zinc oxide, iron oxide, carbon black, and organic colored pigments and dyes.

The saturants can optionally contain light absorbers and/or light stabilizers.

The saturant composition of the present invention can also optionally contain conventional additives, such as but not limited to stabilizers, rheology control agents, flow agents, and toughening agents. Typically useful conventional formulation additives include leveling and flow control agents, for example, Resiflow®S (polybutylacrylate), BYK® 320 or 325 (silicone leveling agents, supplied by BYK Chemie, Wallingford, Conn.), BYK® 347 (polyether-modified siloxane, supplied by BYK Chemie, Wallingford, Conn.) and rheology control agents, such as fumed silica.

Saturant compositions can optionally include fillers. Suitable fillers include, for example, stone powder, mica, lithopone, zinc oxide, zirconium silicate, iron oxides, diatomaceous earth, calcium carbonate, magnesium oxide, chromic oxide, zirconium oxide, aluminum oxide, crushed quartz, calcined clay, talc, kaolin, asbestos, cellulose, wood flour, cork, as well as colorants such as metal flakes, glass flakes and beads, ceramic particles, polymer particles or a combination thereof.

Saturant compositions that contain both polymerization initiator and binder have a limited pot life. When used to manufacture a composite structure, saturant may be present as two separate components: i) binder and ii) polymerization initiator, or as a single composition. When present as two components, binder and polymerization initiator may be conveniently mixed with a standard two component spray gun (commonly employed in the coating industry) as the two components are being sprayed onto the fiber. Alternatively, the two components may be premixed just prior to the saturant being applied to the fiber.

The structures of the present invention can be manufactured by a variety of processes including, but not limited to applying saturant to fiber via spraying, coating, dipping, and impregnating under pressure. Alternatively, fiber and saturant may be simultaneously co-sprayed.

Depending upon the desired texture of the structure, the saturant can be applied to achieve a smooth surface or a roughened or even a coarse surface over all or part of the surface.

After the saturant composition has been applied to the fiber, and the structure optionally shaped, the saturant is cured. Curing preferably takes place at ambient conditions, i.e., in the range of from 10° C. to 50° C. and from 10 percent to 90 percent relative humidity. Optionally, an ultraviolet or infrared light source or other heat source can be used to help accelerate the curing of the saturant composition.

The structures of the invention are particularly suited for use as hulls for watercraft, recreational equipment, tanks, structural laminate panels (e.g. door panels), multilayer laminate systems, flexible fabric systems, pre-coated fibers, laminate films and the abrasion resistant layer in molded parts. Additional utilities for the composites of this invention include impact tie layers (e.g. safety glass) for composite structures, sizing agents for fabrics to impart superior binding of other binding agents, and composite structures made by orientation methods (pultrusion).

Additional attributes of these types of component structures include flexibility, improved impact resistance, weatherability and a robust, non-critical stoichiometry of saturant components required to obtain a high quality part.

### EXAMPLES

### Example 1

The following 3-part saturant system was made. Hypalon® 20 chlorosulfonated polyethylene is available from DuPont Performance Elastomers. Vanax® 808HP is an activator available from R.T. Vanderbilt.

| | |
|---|---|
| Part A | |
| Hypalon ®20 | 35 parts (by weight) |
| Butyl Acryate | 54 parts |
| Ethylene Dimethacrylate | 1 part |
| Part B [Initiator] | |
| Cumene Hydroperoxide | 0.5 parts |
| Part C [Activator] | |
| Vanax ® 808HP | 0.3 parts added just prior to use |

The ingredients of Part A were placed into a glass jar and the closed jar rolled on a rolling table for several hours until the Hypalon® 20 had dissolved. To the solution of Part A was then added Part B and mixed by rolling on the rolling table for several minutes. The solution was set aside, prior to introduction of activator (Part C) while a glass mat was prepared for impregnation.

An 8 inch by 11 inch (20.3 cm×27.9 cm) sample of glass mat was cut from a commercial fabric and placed on a PTFE release surface. Next, to the mixed solution of Part A and B, was added Part C and the resultant saturant briefly mixed by hand with a spatula.

The final solution of saturant was poured onto the glass mat sample and evenly spread over the glass mat with a spatula. Excess material was immediately removed from the glass mat by using a draw down rod. The composite structure of the invention was tack free after 8 minutes and was allowed to set overnight at ambient conditions before being removed from the release sheet.

A Gardner impact test was then run at room temperature, employing ASTM D5420-98. The above composite of the invention, based on the Hypalon® 20 binder system, had an impact strength of 149.8 in.lbs. (16.93 N·m).

### Comparative Example A

The above example was repeated, except that a commercially available Bondo® 420T Resin Repair Kit (saturant) was employed in place of the above described saturant. Bondo® 420T is a styrene and resin mixture and the polymerization initiator system is a mixture of peroxides (available from Bondo Corporation).

The ingredients were mixed according to the instructions accompanying the Bondo® saturant. The resulting saturant was then applied to an 8 inch by 11 inch (20.3 cm×27.9 cm) sample of glass mat as described above to prepare a comparative composite test part. The composite was allowed to stand overnight at ambient conditions before being removed from the PTFE release sheet.

A Gardner impact test was then run at room temperature, employing ASTM D5420-98. The above comparative composite, based on the Bondo® saturant system, had an impact strength of 26.8 in.lbs. (3.028 N·m).

What is claimed is:

1 A composite structure comprising:
A) fiber and
B) a saturant composition comprising: (i) a binder composition and (ii) a polymerization initiator system, wherein said binder composition comprises:
a) 1 to 50 percent by weight, based on total weight of binder, of chlorosulfonated polyolefin; and
b) 99 to 50 percent by weight, based on total weight of binder, of a monomer mixture,
wherein said monomer mixture comprises 10 to 99 weight percent, based on total weight of said monomer mixture, of at least one first monomer selected from the group consisting of acrylic monomers, methacrylic monomers and a mixture of acrylic and methacrylic monomers, wherein said first monomer has a single acrylic or methacrylic group; and 90 to 1 weight percent, based on total weight of said monomer mixture, of at least one second monomer selected from the group consisting of acrylate monomers, methacrylate monomers and a mixture of acrylate and methacrylate monomers, wherein said second monomer has at least two acrylate or methacrylate groups.

2. A composite structure of claim 1 wherein said fiber is present in an amount of at least 10 weight percent, based on total weight of fiber and saturant.

3. A composite structure of claim 2 wherein said fiber is present in an amount of 50 to 60 weight percent, based on total weight of fiber and saturant.

4. A composite structure of claim 1 wherein said first monomer is selected from the group consisting of alkyl acrylates, alkyl methacrylates and a mixture of alkyl acrylate and alkyl methacrylate monomers wherein said alkyl group contains between 3 and 18 carbon atoms.

5. A composite structure of claim 4 wherein said alkyl group contains between 6 and 18 carbon atoms on.

6. A composite structure of claim 1 wherein said polymerization initiator system comprises at least one polymerization initiator and at least one polymerization activator.

7. A composite structure of claim 6 wherein said polymerization initiator is selected from the group consisting of peroxides, peracids, peresters and azo initiators.

8. A composite structure of claim 6 wherein said polymerization activator is selected from the group consisting of amine-based activators and an organic acid salt of a transition metal.

9. A composite structure of claim 1 wherein said chlorosulfonated polyolefin is present in an amount of 10 to 40 weight percent, based on total weight of binder.

10. A composite structure of claim 9 wherein said chlorosulfonated polyolefin is present in an amount of 15 to 30 weight percent, based on total weight of binder.

11. A composite structure of claim 1 wherein up to 50 wt. % of said first monomer having only a single acrylic or methacrylic group is replaced with at least one monomer selected from the group consisting of vinyl esters, vinyl ethers, and styrene.

12. A composite structure of claim 1 wherein up to 25 wt. % of said second monomer having at least two acrylate or methacrylate groups is replaced with at least one monomer selected from the group consisting of liquid polyisoprenes, liquid polybutadienes, limonene, linoleic acid, linolenic acid, a linoleic ester, a linolenic ester, and ortho-, meta-, and para-isomers of N,N-phenylenedimaleimide.
